(19) United States
(12) Patent Application Publication
(10) Pub. No.: US 2017/0270473 A1
(43) Pub. Date: Sep. 21, 2017

(54) SYSTEMS AND METHODS FOR SECURELY SEARCHING AND EXCHANGING DATABASE RELATIONSHIPS BETWEEN REGISTERED INVENTORY

(71) Applicant: GOODEES, INC., Concord, CA (US)

(72) Inventors: Nicola La Gloria, Campbell, CA (US); Andrea Zoleo, San Dona di Piave (IT)

(21) Appl. No.: 15/464,167

(22) Filed: Mar. 20, 2017

Related U.S. Application Data
(60) Provisional application No. 62/310,492, filed on Mar. 18, 2016.

(51) Int. Cl. G06Q 10/08; G06K 7/10

(52) U.S. Cl. CPC G06Q 10/087; G06K 7/10861

(57) ABSTRACT

Embodiments described herein are directed at inventory tracking system that use labels (e.g., two dimensional (2D) DataMatrix™/QR Code™ objects, or virtual labels) including encoded unique identifiers (e.g., a code) to track physical items as they are transferred and/or controlled by different registered entities of the inventory tracking system. In some embodiments, the system includes a mobile application that scans a special label attached to an item (e.g., a hammer) or generates a unique virtual label for the item to register the item. The system can then track the personal inventory of the user and allow the user to track lending, re-lending, donation, and any other interactions related to the item with other registered entities scanning the physical or the virtual labels associated with the item. The item transactions may be incentivized through gamification features to regulate and drive further adoption by users.

### CROSS-REFERENCES TO RELATED APPLICATIONS

This application claims the benefit of U.S. Provisional Patent Application No. 62/310,492, filed Mar. 18, 2016, entitled “Systems and Methods for Securely Searching and Exchanging Database Relationships Between Registered Inventory,” which is incorporated herein by reference.

### BACKGROUND OF THE INVENTION

There exists systems and social platforms for the sale of used items. In such conventional systems, the owner of the used item places a post (e.g. an ad) including details about the item, optionally a photograph depicting the item and the price asked for the item. The post also includes contact information (e.g. an email address or a phone number) of the owner. Users of the system or the social platform may access the post, contact the owner, and purchase the item. The owner may ship or deliver the item, or the buyer may pick up the item from the owner.

However, existing systems do not support borrowing of items owned by a user of the system. The main challenge of a borrowing system is the tracking of items in transaction. Accurate tracking may require a unique identifier for each item registered in the system. There exists a need for reducing network communication (thereby the efficiency of the computer systems involved by reducing processing power and consumption of resources for such communication) improving for management and discovery of items in a borrowing system.

Embodiments of the invention address these and other problems.

### BRIEF SUMMARY OF THE INVENTION

Embodiments described herein are directed at inventory tracking system that use labels (e.g., two dimensional (2D) DataMatrix™/QR Code™ objects, or virtual labels) including encoded unique identifiers (e.g., a code) to track physical items as they are transferred and/or controlled by different registered entities of the inventory tracking system. In some embodiments, the system includes a mobile application that scans a special label attached to an item (e.g., a hammer) or generates a unique virtual label for the item to register the item with the inventory tracking system. The system may also register users, and associate items with a registered user. The system can then track the personal inventory of a user and allow the user to track lending, sale, re-lending, donation, and any other interactions related to an item with other registered entities. The item transactions may be incentivized through gamification features to regulate and drive further adoption by users.

Embodiments generate a unique label for each item using an exemplary label issuing system. The label issuing system includes a plurality of label issuing computers each of which includes a label generation module and a label authentication module. Each label generation module in turn may include one or more servers that generate, in a distributed and balanced way, an alphanumerical code that will form a part of a label. Each label may have a node identifier portion (e.g. a URL address) identifying the label generation module that generated the label, a lot identifying portion identifying the entity that requested the label and a code portion (i.e. the alpha-numerical code) that is generated by a server of the label generation module.

An exemplary embodiment provides a method performed by an inventory labeling and tracking system. The inventory labeling and tracking system receives a label generation request to generate a label from a label requestor and identifies a label issuing computer among a plurality of label issuing computers based on a pre-determined criteria. The inventory labeling and tracking system sends the label generation request to the label issuing computer. The inventory labeling and tracking system generates a label in response to the label generation request using the label issuing computer. The label includes at least a first portion identifying the label issuing computer, and a second portion including an alpha-numerical code generated by the label issuing computer. The inventory labeling and tracking system returns the label to the label requestor. At a later time, the inventory labeling and tracking system receives a transaction request including the label. The inventory labeling and tracking system determines that the label is generated by the label issuing computer based on the first portion of the label identifying the label issuing computer. The inventory labeling and tracking system transmits the label to the label issuing computer for validation and receives a validation result from the label issuing computer. The inventory labeling and tracking system processes the transaction request based on the validation result.

Another exemplary embodiment provides a method performed by a label issuing computer of an inventory labeling and tracking system. The label issuing computer receives a label generation request to generate a label for a label requestor and generates a label in response to the label generation request. The label includes at least a first portion identifying the label issuing computer, and a second portion including a unique alpha-numerical code generated by the label issuing computer. The label issuing computer returns the label to the label requestor. At a later time, the label issuing computer receives the label for validation. The validation includes validating that the label is generated by the label issuing computer. The label issuing computer analyzes the label to determine whether the label is generated by the label issuing computer, and transmits a validation result to the inventory labeling and tracking system. A transaction including the label is authorized based on the validation result.

Embodiments provide a labeling and tracking system comprising at least one database, a plurality of label issuing computers for issuing a plurality of labels, and an inventory tracking server in communication with the plurality of label issuing computers. The inventory tracking server includes a processor, an item registration module, a load distribution module, and an item exchange processing module. The item registration module is programmed to receive a label generation request to generate a label from a label requestor, and store a label along with a description of an item associated with the label at the at least one database. The load distribution module is programmed to identify a label issuing computer among the plurality of label issuing computers, send the label generation request to the label issuing computer, and receive the label from the label issuing computer. The label includes at least a first portion identifying the label issuing computer, and a second portion including an alpha-numerical code generated by the label issuing computer. The item exchange processing module is programmed to receive a transaction request including the label, wherein the transaction request is associated with the item identified by the label, determine that the label is generated by the label issuing computer based on the first portion of the label identifying the label issuing computer, transmit the label to the label issuing computer for validation, receive a validation result from the label issuing computer, and process the transaction request based on the validation result.

For a further understanding of the nature and advantages of the invention, reference should be made to the following description taken in conjunction with the accompanying figures. It is to be expressly understood, however, that each of the figures is provided for the purpose of illustration and description only and is not intended as a definition of the limits of the embodiments of the present invention.

### BRIEF DESCRIPTION OF THE DRAWINGS

FIG. 1 illustrates an exemplary block diagram of a labeling and tracking system, according to various embodiments.

FIG. 2 illustrates an exemplary label generated by a label generation module of the labeling and tracking system, according to various embodiments.

FIG. 3 illustrates an exemplary method for generating a plurality of unique code portions of corresponding labels, according to various embodiments.

FIG. 4 illustrates an exemplary registered item database and data structure stored thereon, according to various embodiments.

FIG. 5 illustrates a flowchart of steps for registering and listing an item using the labeling and tracking system, according to various embodiments.

FIG. 6 illustrates a flowchart of steps for borrowing an item using the labeling and tracking system, according to various embodiments.

FIG. 7 illustrates a flowchart of steps for registering/listing an item with the labeling and tracking system by generating a virtual label using the labeling and tracking system, according to various embodiments.

FIG. 8 illustrates a flowchart of steps for borrowing an item using a virtual label through the labeling and tracking system is illustrated, according to various embodiments

FIG. 9 illustrates a flowchart of steps for label substitution using the labeling and tracking system, according to various embodiments.

FIG. 10 illustrates an exemplary computer system for performing embodiments of the present invention.

### DETAILED DESCRIPTION OF THE INVENTION

Embodiments described herein are directed at inventory tracking system that use labels (e.g., two dimensional (2D) DataMatrix™/QR Code™ objects, or virtual labels) including encoded unique identifiers (e.g., a code) to track physical items as they are transferred and/or controlled by different registered entities of the inventory tracking system. In some embodiments, the system includes a mobile application that is capable of scanning a special label attached to an item (e.g., a hammer) or generating a unique virtual label for the item to register the item with the inventory tracking system. According to various embodiments, users are also registered with the inventory tracking system. The system can then track the personal inventory of a given user and allow the user to track lending, sale, re-lending, donation, and any other interactions related to the item with other registered entities. The item transactions may be incentivized through gamification features to regulate and drive further adoption by users.

Embodiments generate a unique label for each item using an exemplary label issuing system. The label issuing system includes a plurality of label issuing computers each of which includes a label generation module and a label authentication module. Each label may have a node identifier portion (e.g. a URI/URL address) identifying the label generation module that generated the label, a lot identifying portion identifying the entity that requested the label and a code portion (i.e. alpha-numerical code) that is generated by a server of the label generation module.

Embodiments provide enhanced security aspects including (1) generation of unique labels by label issuers to ensure only authorized labels can be used with the system and that labels cannot be replicated, and (2) encryption of label information and validation of labels during inventory transactions. In some embodiments, the server generating the alpha-numerical code portion of the label may add padding bits to the alpha-numerical code to generate a padded alpha-numerical code. The server may then encrypt the padded alpha-numerical code using various encryption techniques. According to some embodiments, the server may encrypt the alpha-numerical code without using padding bits. Either approach provides enhanced security aspects to protect the labels from being replicated such that a unique label is used for each item registered with the system.

According to various embodiments, a lending transaction may include: (1) a borrower scanning a label associated with a registered item using a mobile application on their device, (2) the system validating the authenticity of the code by directing the request to a server computer configured to manage issued label requests, (3) when the computer validates the label code, the registered owner of the item is contacted and authorization for the lending transaction is requested, (4) when the owner agrees to the transaction, the relationship of the registered item in an item database is updated with the transaction information to indicate that the borrower is in possession of the item (i.e., the borrower becomes an item holder), and (5) an item may be returned and the registered item database may be updated as the item being returned once the owner scans the label using their mobile device (a similar authentication and database update may be performed at the server computer).

### Item Identification, Verification, and Interaction Systems

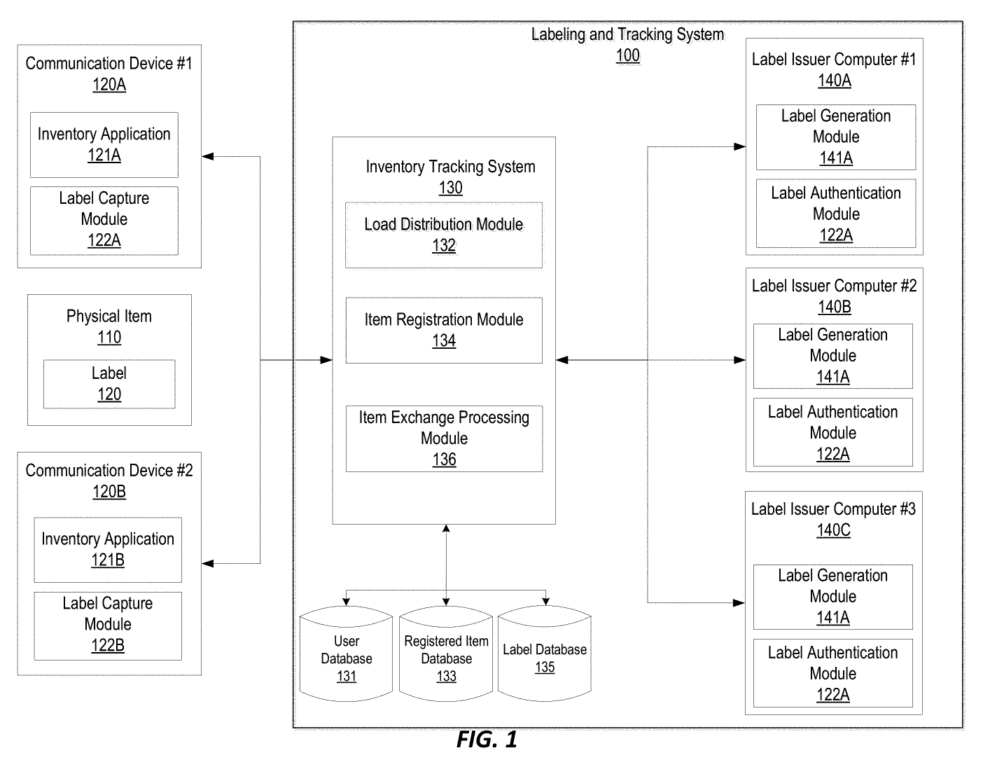

FIG. 1 diagrammatically illustrates a labeling and tracking system 100, according to one embodiment of the present invention. The labeling and tracking system 100 may include various components such as an inventory tracking system 130 and a plurality of label issuer computers 140A, 140B, 140C. The inventory tracking system 130 may be in communication with a user database 131, a registered item database 133 and a label database 135. The user database 131 may store information associated with users registered with the inventory tracking system 130. The registered item database 133 may store information associated with one or more items of a registered user that the user wishes to make available to other users through the inventory tracking system 130. The label database 135 may store labels generated by the label issuer computers 140A, 140B, 140C. The label database 135 may also store a mapping between a registered item and a label associated with the registered item. In some embodiments, the mapping information (i.e. mapping between a registered item and a label associated with the registered item) may also be stored at the registered item database 133.

A registered user may interact with the inventory tracking system 130 using a communication device 120A or 120B. Each user may be a borrower and/or a lender for an item. More specifically, a given registered user may be a lender for a particular item. All other registered users may be borrowers for that particular item. An inventory application 121A, 121B may be provided on the communication device 120A, 120B, respectively.

For example, a first registered user may wish to borrow an item 110 listed by a second registered user. The first registered user may search for and select the item 110 via the inventory application 121A provided on the communication device 120A of the first registered user. The first registered user may contact the second registered user via the inventory application 121A. The second registered user (e.g. the owner or “lister” of the item) may receive a communication from the first registered user requesting borrowing the item 110 via the inventory application 121B provided on the communication device 120B of the second registered user. The users may agree to meet at a place, or may agree that the second user will ship the item 110 to the first user. The second user may then scan a label 120 (physical or virtual) associated with the item 110 to indicate that the item 110 is no longer available for borrowing on the inventory tracking system 130. The second user may scan the label 120 using the label capture module 122B (e.g. QR code scanner, code reader, etc.) of the communication device 120B. Upon receipt of the item 110, the first user may scan the label 120 using the label capture module 122A of the communication device 120A to notify the inventory tracking system 130 that the item 110 is now in possession of the first user. When the first user returns the item 110 to the second user, the first user and the second user scan the label 120 to indicate that the item 110 is being returned by the first user and is now in possession of the second user, respectively.

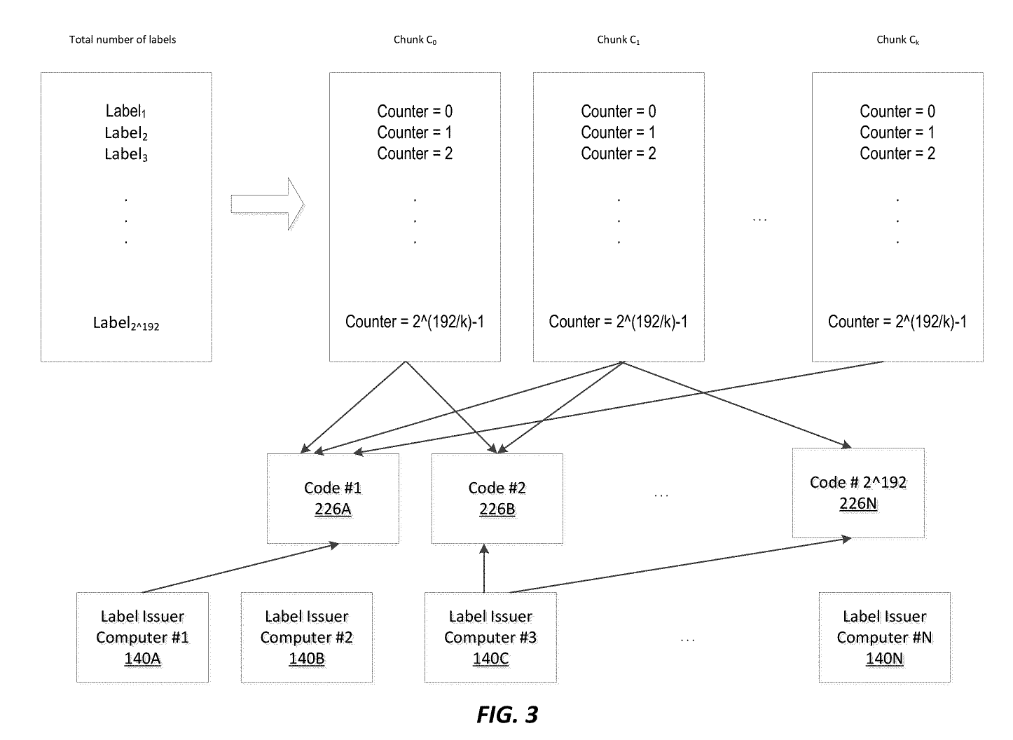

According to various embodiments, the inventory tracking system 130 may include a load distribution module 132, an item registration module 134 and an item exchange processing module 136. The load distribution module 132 may be in communication with a plurality of label issuer computers 140A, 140B, 140C to oversee the generation of a plurality of labels using the label generation modules 141A, 141B, 141C of the label issuer computers 140A, 140B, 140C. The label generation process is discussed below in greater detail in connection with FIG. 3. The label issuer computers 140A, 140B, 140C operate independently and in parallel. One of ordinary skill in the art will appreciate that the labeling and tracking system 100 may include any number of label issuer computers and is not limited to the label issuer computers 140A, 140B, 140C illustrated in FIG. 1.

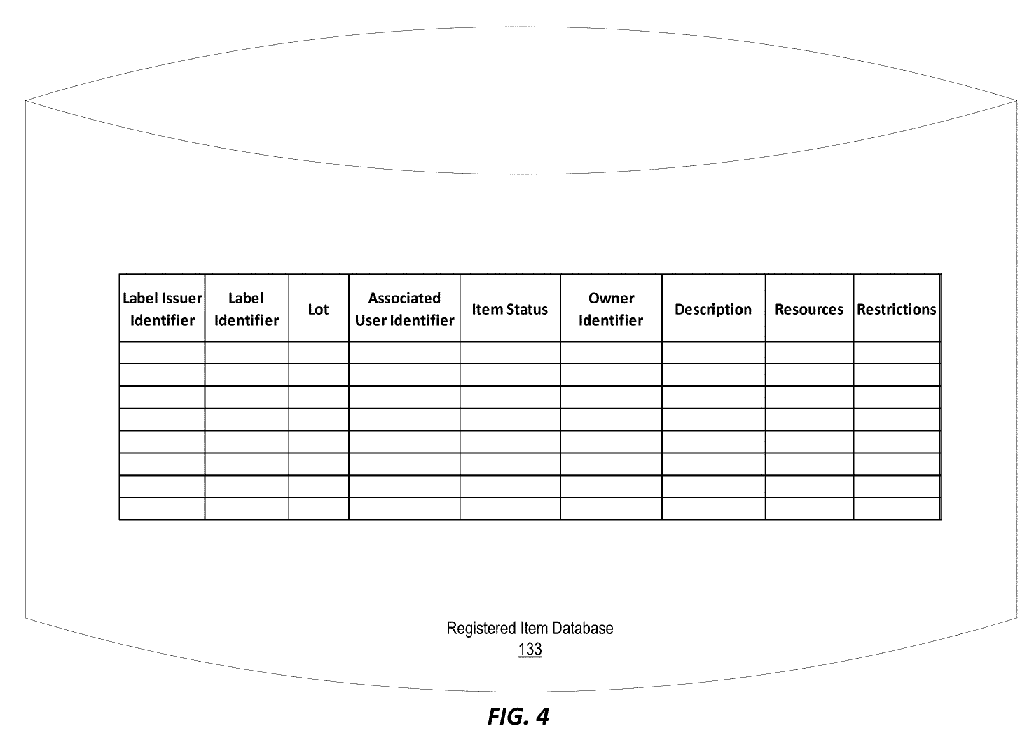

The item registration module 134 receives registration requests from registered users. For example, in the foregoing example, the second user (e.g. the owner of the item 110) may wish to register/list item 110 with the inventory tracking system 130. The item registration module 134 requires a label 120 to be associated with the item 110. The label 120 may be a physical label attached to the item 110 or a virtual label associated with the item 110. If a label has not been generated for the item 110, the item registration module 134 contacts the load distribution module 132 and requests a label to be generated for the item 110. If a label 120 is already generated for the item 110 (or is generated upon the item registration module's request), the item registration module 134 generates an entry in the registered item database 133 for the item 110. For example, the database entry may include one or more of a description of the item 110, a picture of the item 110, a location of the item 110, a value associated with the item 110, etc. The database entry may also store the label 120 associated with the item 110. An exemplary database format for the registered items database 133 is illustrated in FIG. 4.

The item exchange processing module 136 oversees the transaction (e.g. the process of lending/borrowing) of the item 110. For example, in the foregoing example, the item exchange processing module 136 receives a borrowing request (e.g. a borrowing request message) from the communication device 120A of the first user to borrow item 110. The item exchange processing module 136 may send the borrowing request to the communication device 120B of the second user. In some embodiments, the first user may directly send the borrowing request to the communication device 120B of the second user. When the second user scans the label 120 of item 110 using label capture module 122B of the communication device 120B, the item exchange processing module 136 receives a first status update request for the item 110. The item exchange processing module 136 updates the status of the item 110 in the registered item database 133 to indicate that borrowing is requested for the item 110. When the first user receives the item 110 and scans the label 120 using the label capture module 122A of the communication device 120A, the item exchange processing module 136 receives a second status update request for the item 110. The item exchange processing module 136 updates the status of the item 110 in the registered item database 133 to indicate that the item 110 is now borrowed and in possession of the first user.

Similarly, during the returning of the item 110 to its owner, the first user scans the label 120 of item 110 using label capture module 122A of the communication device 120A, the item exchange processing module 136 receives a third status update request for the item 110. The item exchange processing module 136 updates the status of the item 110 in the registered item database 133 to indicate that item 110 is in the processed of being returned to the second user (e.g. owner/lister of the item 110). When the second user receives the item 110 and scans the label 120 using the label capture module 122B of the communication device 120B, the item exchange processing module 136 receives a fourth status update request for the item 110. The item exchange processing module 136 updates the status of the item 110 in the registered item database 133 to indicate that the item 110 is now returned and in possession of the second user.

During the borrowing/returning of the item 110, the item exchange processing module 136 may also update the status of the registered users (e.g. the first user and the second user) in the user database 131. For example, when the item exchange processing module 136 receives the second status update request for the item 110, the item exchange processing module 136 updates the status of the first user in the user database 131 to indicate that the first user is now in possession of the item 110. The item exchange processing module 136 may also update the status of the second user in the user database 131 to indicate that the second user is no longer in possession of the item 110. When the item 110 is returned to the second user (i.e. when the item exchange processing module 136 receives the fourth status update request for the item 110), the item exchange processing module 136 updates the status of the first user in the user database 131 to indicate that the first user is no longer in possession of the item 110. The item exchange processing module 136 may also update the status of the second user in the user database 131 to indicate that the second user is now in possession of the item 110.

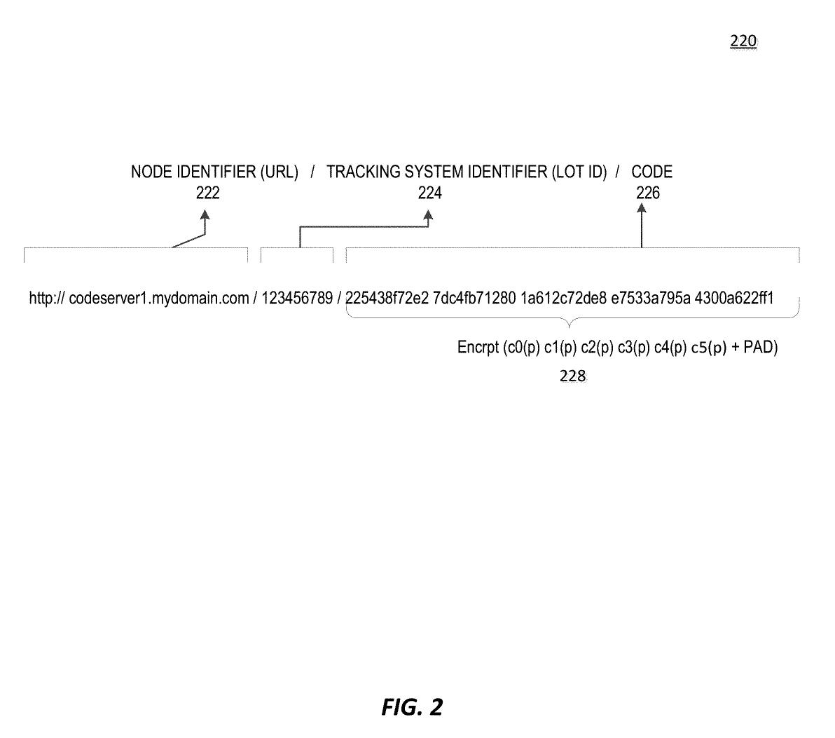

A status update request received at the item exchange processing module 136 may include a label (e.g. label 120). Before updating the registered item database 133 or the user database 131 (e.g. before processing the status update request), the item exchange processing module 136 may request authentication of the label. That is, the item exchange processing module 136 may confirm that the received label is a valid label generated by the labeling and tracking system 100. The item exchange processing module 136 may analyze the received label and parse the label to determine the label issuer computer 140A, 140B or 140C that generated the label. The item exchange processing module 136 may then send the label to the identified label issuer computer 140A, 140B or 140C for authentication (i.e. validation). Upon receipt, the label issuer computer 140A, 140B or 140C may authenticate the label using the label authentication module 122A, 122B or 122C of that label issuer computer 140A, 140B or 140C, respectively. The label authentication module 122A, 122B or 122C may decrypt the code portion of the label (as further described below in connection with FIGS. 2 and 3), and determine whether the decrypted code portion is generated by the label issuer computer 140A, 140B or 140C. The label issuer computer 140A, 140B or 140C returns the authentication results to the item exchange processing module 136. If the label is authenticated, the item exchange processing module 136 may process the status update request as described above. If the label is not authenticated, the item exchange processing module 136 may decline the status update request.

FIG. 2 illustrates an exemplary label 220. According to various embodiments, the label 220 may be formed of multiple sections/portions. For example, the label 220 may be formed of a node identifier portion 222, a tracking system identifier portion 224 and a code portion 226. In some embodiments, the node identifier portion 222 may be a Uniform Resource Identifier (URI) such as a Uniform Resource Locator (URL). The node identifier portion 222 identifies the server that generated the label. For example, the node identifier portion 222 may be an identifier for any one of the label issuer computers 140A, 140B or 140C, illustrated in FIG. 1. Accordingly, when the item exchange processing module 136 receives a label in a status update request, the item exchange processing module 136 may analyze the received label to determine the node identifier portion 222 of the label. The node identifier portion 222 identifies one of the issuer computers 140A, 140B or 140C.

The tracking system identifier portion 224 may also be referred as a lot identifier (LOT ID). The tracking system identifier portion 224 identifies the tracking system that includes the label issuer computer that generated the label. For example, in the exemplary system illustrated in FIG. 1, the inventory application 121A may be provided by a first entity, and the inventory application 121B may be provided by a second entity. The tracking system identifier portion 224 of the label may identify if the label has been generated for (e.g. associated with) the first entity or the second entity. Each one of the issuer computer 140A, 140B and 140C may generate multiple labels for various different entities (e.g. the first entity, the second entity, etc.).

The code portion 226 of the label 220 is a unique code generated by the label issuer computer. A code can be a 192 bit number. Accordingly, N=2¹⁹² number of code portions (e.g. labels) can be generated by the labeling and tracking system 100. The 192 bits can be partitioned, for example, into 6 blocks of 32 bit each that can be represented by a type long ranging from 0 to 2³²−1 (number is not signed). A general code partitioning may be represented in symbols as:

$$c = \begin{matrix}\underbrace{{c}_{0}}_{32 bit} & \underbrace{{c}_{1}}_{32 bit} & \underbrace{{c}_{2}}_{32 bit} & \underbrace{{c}_{3}}_{32 bit} & \underbrace{{c}_{4}}_{32 bit} & \underbrace{{c}_{5}}_{32 bit}\end{matrix}$$

where cₖ is a particular chunk or counter. This number can be represented as a byte stream (e.g. a string) and encrypted. The string may be encoded into a data matrix (e.g. a two dimensional barcode). Each chunk can include 2³² counter values (around 4 billion code portions). That is, each chunk can have counter values in the range of [0, 2³²−1]. Every chunk (or counter) can be subdivided into more sub-intervals or segments of sequential integers. This logic may be stored in the inventory tracking system 130, such as the item registration module 134. That is, the entire interval [0, 2³²] of each chunk may be divided in arbitrary length segments according to various embodiments.

Every chunk is a counter, and accordingly, each chunk is incremental. The partitioning can be represented as a multidimensional space (e.g. 6 dimensions in this case) and then the entire volume of the hypercube (multidimensional space) is total number of code portions that can be issued by the entire system: V=2¹⁹². The hypercube can be interpreted as a group of codes with some type of relation (e.g. belong to the same geographic area), every single point of the hypercube (e.g. a code portion, a label) can be issued and managed by a different issuer computer server.

This code partitioning may be done due to (1) the ability of conventional computer machines of handing 64 bit at most, and (2) the ability of the labeling and tracking system 100 to distribute the generation and validation of the labels among a cluster of computer machines (i.e. the label issuer computers).

A unique code portion for the label “p”, is a particular value of each counter: c0(p) c1(p) c2(p) c3(p) c4(p) c5(p). Chunks can be used very differently according to various embodiments. For example, a sub interval of a counter (e.g. the counter c3) may be used to assign labels to different geographic areas. As illustrated in FIG. 3, each code portion 226A-226N is generated by one of the label issuer computers 140A-140N. The label issuer computer (e.g. label issuer computer 140A) generates the code portion (e.g. code portion 226A) of the corresponding label by using one or more of the chunks C0-C6. Accordingly, the code portion 226A may be generated by using only one chunk or a plurality of chunks. In some embodiments, some of the chunk values may be “0”.

In an exemplary embodiment, the label issuer computer 140A may include a label generation module 141A that generates codes. Every counter or a sub-segment of a counter may have a minimum and maximum value allowed and the counter is incremented within that interval (e.g. range), for example for the counter sub-segment 1 of the counter k:

c_{k,l}=[p,p+q]ₖ∀p, (p+q)∈[0,2³²−1]

The maximum number of incremental values handled by the counter k in this partitioning is [p,p+q]ₖ or N=(p+q)−p=q.

Each counter may have partitioned by the inventory tracking system 130 into arbitrary sub-segments.

As provided above, a unique code portion for the label “p” may be represented as c0(p) c1(p) c2(p) c3(p) c4(p) c5(p). In some embodiments, the code portion may be encrypted to increase the security of the system. Prior to encryption, padding bits may be added to the label, e.g. (c0(p) c1(p) c2(p) c3(p) c4(p) c5(p)+PAD). For example, the code portion may originally be 192 bit, by adding padding of another 64 bits, a 256 bit sequence may be encrypted using an encryption algorithm such as Advanced Encryption Standard (AES) encryption with a 256 bit key.

$$code = \overbrace{\begin{matrix}\underbrace{{c}_{0} {c}_{1} {c}_{2} {c}_{3} {c}_{4} {c}_{5}}_{192 bit} & \underbrace{0 … 0}_{64 bit padding}\end{matrix}}^{256 bit}$$

$$encrypted code = crypt ( \overbrace{\begin{matrix}\underbrace{{c}_{0} {c}_{1} {c}_{2} {c}_{3} {c}_{4} {c}_{5}}_{192 bit} & \underbrace{0 … 0}_{64 bit padding}\end{matrix}}^{256 bit} )$$

Accordingly, the label issuing process starts with one of the label issuing computers of the inventory labeling and tracking system receiving a label generation request to generate a label for a label requestor. For example, the label requestor may be a user of the inventory labeling and tracking system. The label issuing computer may generate a label in response to the label generation request. As provided above, the label may include at least a first portion identifying the label issuing computer, and a second portion including a unique alpha-numerical code generated by the label issuing computer. In some embodiments, the label issuing computer may encrypt the label (e.g. the unique alpha-numerical code). In yet other embodiments, the label issuing computer may add padding bits to the unique alpha-numerical code and encrypt the unique alpha-numerical code along with the padding bits. The label issuing computer may encode the unique alpha-numerical code into a data matrix.

The label issuing computer may return the label to the label requestor. In some embodiments, the label issuing computer may return the label to an inventory tracking system of the inventory labeling and tracking system which is in communication with the user of the inventory labeling and tracking system. The inventory tracking system may return the label to the label requestor (e.g. the user). At a later time, when the user contacts the inventory labeling and tracking system for a transaction (e.g. to borrow an item associated with the label), the label issuing computer may receive the label for validation. For example, the user may transmit a request to borrow the item associated with the label to the inventory tracking system. Upon receiving the label and before processing the borrowing transaction, the inventory tracking system may need to verify that the label provided by the user is authentic. The inventory tracking system may parse the label to identify the label issuing computer that generated the label (for example, a portion (e.g. a first portion) of the label may include an identifier for the label issuing computer). The inventory tracking system may then provide the label to the label issuing computer for verification (e.g. authentication).

The label issuing computer may analyze the label to determine whether the label is generated by the label issuing computer. For example, the label may be encrypted. If the label issuing computer is able to decrypt the label (e.g. if the label issuing computer is in possession of the decryption key or decryption algorithm), the label issuing computer may validate the label. The validation includes validating that the label is generated by the label issuing computer. The label issuing computer may then transmit a validation result to the inventory labeling and tracking system. The label issuing computer may generate the validation result validating the label if the label is decrypted using the decryption algorithm, and the validation result not validating the label if the label cannot be decrypted using the decryption algorithm. The labeling and tracking system may authorize (or decline) the borrowing transaction based on the validation result.

In some embodiments, the label issuing computer may generate the label using values of various counters available to the label issuing computer. For example, the label issuing computer may retrieve a value of a first counter and a value of a second counter. The label issuing computer may then form the unique alpha-numerical code by using the value of the first counter and the value of the second counter. The value of the first counter forms a first portion of the unique alpha-numerical code and the value of the second counter forms a second portion of the unique alpha-numerical code. That is, the label issuing computer retrieves a value of a first counter, such that the value of the first counter forms a first portion of the plurality of portions of the unique alpha-numerical code, and retrieves a value of a second counter, such that the value of the second counter forms a second portion of the plurality of portions of the unique alpha-numerical code.

According to various embodiments, the first counter may identify a first property of an item identified by the label and the second counter may identify a second property of the item identified by the label. For example, the first counter may indicate a geographical location. Thus, when a label issuing computer retrieves a portion of the label that the label issuing computer is generating, the first portion indicates the geographical location of the item for which the label is being generated.

As provided above, when the item exchange processing module 136 receives a status update request including a label, the item exchange processing module 136 may request authentication of the label. That is, the item exchange processing module 136 may confirm that the received label is a valid label generated by the labeling and tracking system 100. The item exchange processing module 136 may analyze the received label and determine that, for example, the label issuer computer 140A has generated the label based on the node identifier of that label. The item exchange processing module 136 may then send the label to the label issuer computer 140A for authentication. Upon receipt, the label authentication module 122A of the label issuer computer 140A may decrypt the encrypted code portion of the label. If the decryption is successful, the label authentication module 122A may confirm that the label is authentic (e.g. may authenticate/verify the label).

The load distribution module 132 of the inventory tracking system 130 may monitor the workload and/or processing speed of the label issuer computers 140A, 140B and 140C. The load distribution module 132 selects one of the label issuer computers 140A, 140B, 140C based on the respective workload and/or processing speed of the label issuer computers. In some embodiments, the load distribution module 132 may use consistent hashing algorithm to distribute the label generation requests equally among available label issuer computers. The item registration module 134 may determine that a label should be generated using selected value(s) of one or more counters. The load distribution module 132 then instructs the selected label issuer computer to generate a label with the code portion formed by using the selected values of the one or more counters. The selected label issuer computer then generates the label in light of the instructions received from the load distribution module 132.

The load distribution module 132 may use various techniques, such as consistent hashing technique, in selecting the label issuer computer for issuing a new label and assigning the value(s) of the one or more counters. If the consistent hashing technique is used, the load distribution module 132 may generate a key and apply the hash function to the key. From the generated hash, the load distribution module 132 may select the label issuer computer among the plurality of label issuer computers 140A, 140B and 140C. The load distribution module 132 may store the (key, URI) key-value pair. The label “p” (c0(p) c1(p) c2(p) c3(p) c4(p) c5(p)+PAD) is generated by the label issuer computer identified by the URI. The label issuer computer sends the generated label to the load distribution module 132.

Referring back to FIG. 2, the exemplary label 220 has encoded the node identifier 222, so when then the label 220 is scanned using, for example, the inventory application 121A, 121B on the communication device 120A, 120B, respectively, the inventory tracking system 130 can forward the request to the correct label issuer computer. Moreover the label 220 also contains the tracking system identifier 224 that the label issuer computer has issued label 220 for. Only the label issuer computer that issued the label 220 for a particular tracking system can validate the label 220 issued for that tracking system. According to various embodiments, a tracking system may be spread over different label issuer computers, or different tracking systems may share the same label issuer computer. The labeling and tracking system 100 can be potentially distributed over a network, processing requests coming from millions of different users.

### Methods Using the Labeling and Tracking System

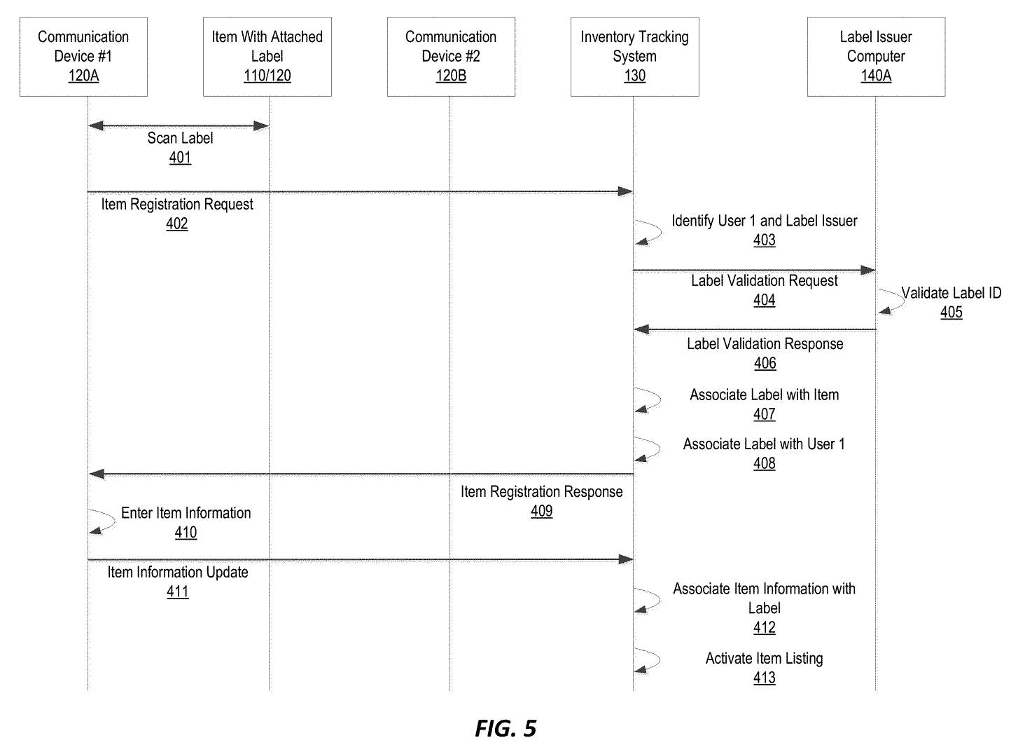

FIG. 5 diagrammatically illustrates a method of registering and listing an item using the labeling and tracking system, according to various embodiments. An item exchange mechanism between two users may take place through the following process: a first registered user scans a label using a communication device of the first user (step 401). The communication device of the first user sends an item registration request to the inventory tracking system using, for example, SSL connection (step 402). The inventory tracking system identifies the first user and the label issuer computer that generated the label (step 403). The inventory tracking system sends a label validation request to the label issuer computer using, for example, SSL connection (step 404). The label issuer computer may analyze the label and validate the label as being a valid label (step 405). The label issuer computer may send a label validation response to the inventory tracking system (step 406). The inventory tracking system associates the label with the item (step 407) and associates the label with the first user (step 408). For example, the inventory tracking system may save the label as an item attribute in the registered item database. The first user may be saved as the owner and holder of the new registered item in the database. The inventory tracking system then sends an item registration response to the communication device of the first user (step 409). The first user may provide item description using the communication device of the first user (step 410). The communication device of the first user may send an item information update request/message to the inventory tracking system (step 411). The inventory tracking system associates the item information with the label (step 412). The inventory tracking system activates the item listing (step 413).

At a later time, the first registered user and the second registered user initiates an exchange transaction (for the registered item) that updates the relationship between the item and the first user. In particular, in the foregoing example, the holding relationship with the item us updated from the first user to the second user.

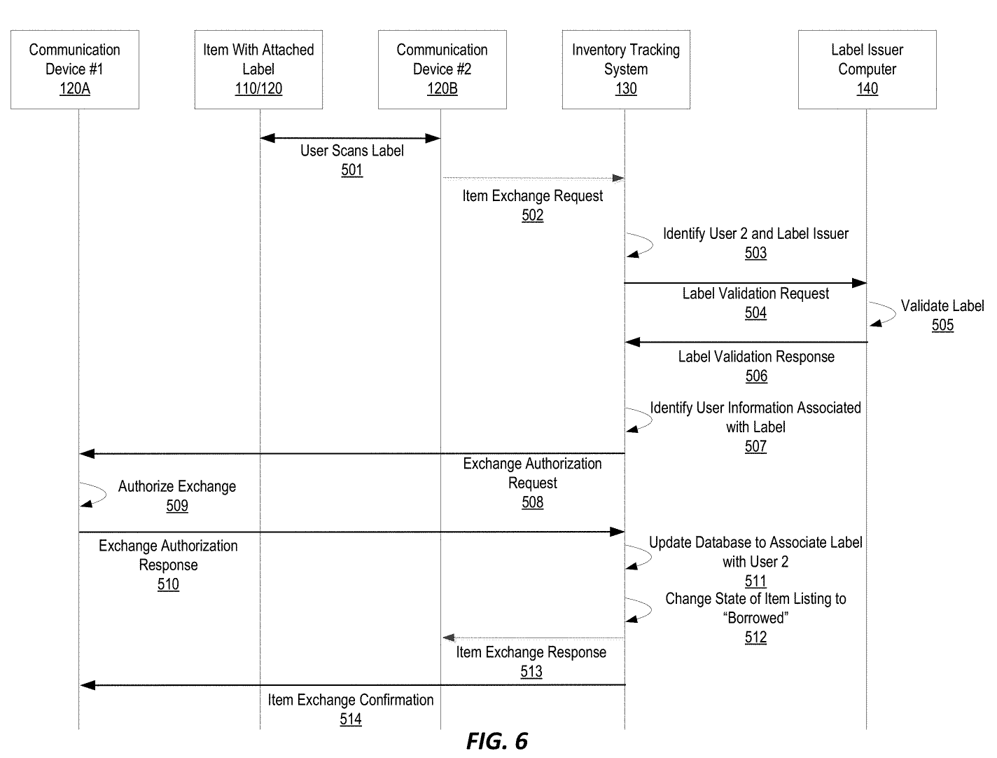

Referring now to FIG. 6, a flowchart of steps for borrowing an item using the labeling and tracking system is illustrated, according to various embodiments. The second user scans the label associated with the item using the communication device of the second user (step 501). The communication device of the second user sends the label to the inventory tracking system using, for example, an SSL connection (step 502). The inventory tracking system identified the second user and the label issuer computer that issued the label (step 503). The inventory tracking system sends the label to the identified label issuer computer using, for example, an SSL connection (step 504). The label issuer computer may verify the validity of the label (step 505) and send a label validation response to the inventory tracking system (step 506). The inventory tracking system identifies the user information associated with the label (step 507). The inventory tracking system sends an exchange authorization request to the communication device of the first user (step 508). The first user authorizes the exchange on the communication device of the first user (step 509). The communication device of the first user sends an exchange authorization response to the inventory tracking system (step 510). The inventory tracking system updates the database to associate the label with the second user (step 511) and changes the state of the item listing to “borrowed” or “inactive” (step 512). The inventory tracking system sends an item exchange response to the communication device of the second user (step 513). The inventory tracking system also sends an item exchange confirmation to the communication device of the first user (step 514).

Referring back to FIG. 5, if the item 110 is not already associated with a label 120, the first user may request the generation of a new label from the inventory tracking system using the communication device of the first user.

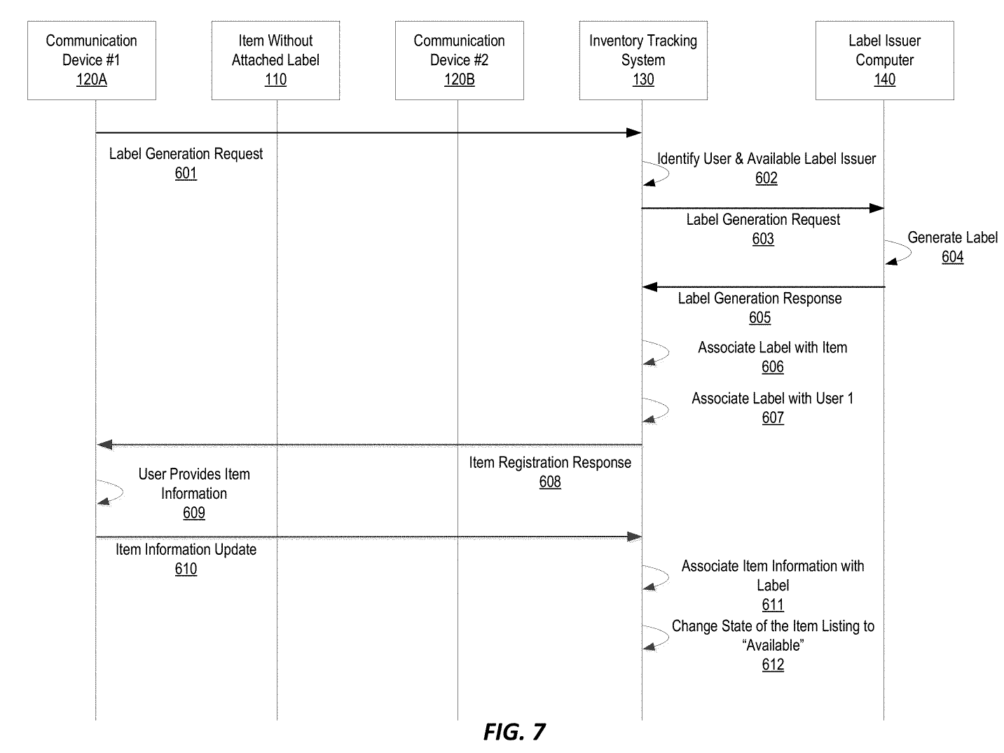

FIG. 7 illustrates a flowchart of steps for registering/listing an item with the labeling and tracking system by generating a virtual label using the labeling and tracking system, according to various embodiments. The first user may send a label generation request to the inventory tracking system using the communication device of the first user (step 601). The inventory tracking system may identify the user and also identify a label issuer computer that can generate the label (step 602). In some embodiments, the inventory tracking system may identify the label issuer computer based on a processing speed and/or a work load of the label issuer computer. The inventory tracking system may send a label generation request to the identified label issuer computer (step 603). The label issuer computer may generate the label (step 604) and send a label generation response to the inventory tracking system (step 605). The label generation response may include the newly generated label. The inventory tracking system may associate the label with the item on the database (step 606) and associate the label with the first user on the database (step 607). The inventory tracking system may send an item registration response to the communication device of the first user (step 608). The first user may provide item information on the communication device of the first user (step 609). The first user may send the item information to the inventory tracking system using the communication device of the first user (step 610). The inventory tracking system may update the database to associate the item information with the label (step 611). The inventory tracking system may also change the status of the item listing to “available” (step 612). The label is now associated with the item, the item is available for borrowing and the item has a relationship with the first user in the database (e.g. the first user is owner and holder of the new registered item).

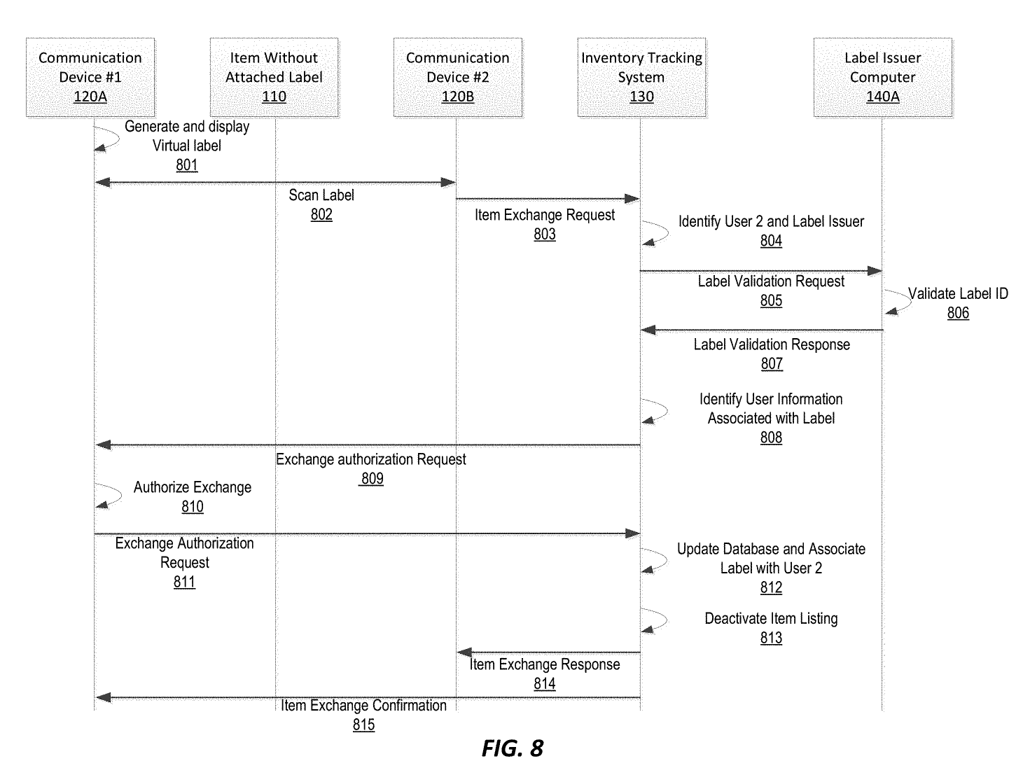

Referring now to FIG. 8, a flowchart of steps for borrowing an item using a virtual label through the labeling and tracking system is illustrated, according to various embodiments. In this embodiment, since a virtual label is used, no label is attached to the item 110. The first user is the owner of the item 110, and the second user 110 would like to borrow the item 110 from the first user. The first user generates (e.g. requests the inventory tracking system 130 to generate) and displays a virtual label on the communication device of the first user (step 801). The second user scans the virtual label associated with the item using the communication device of the second user (step 802). The communication device of the second user sends an item exchange request including the scanned label to the inventory tracking system using, for example, an SSL connection (step 803). The inventory tracking system identifies the second user and the label issuer computer that issued the label (step 804). The inventory tracking system sends the label to the identified label issuer computer using, for example, an SSL connection, for validation (step 805). The label issuer computer may verify the validity of the label (step 806) and send a label validation response to the inventory tracking system (step 807). The inventory tracking system identifies the user information associated with the label (step 808). The inventory tracking system sends an exchange authorization request to the communication device of the first user (step 809). The first user authorizes the exchange on the communication device of the first user (step 810). The communication device of the first user sends an exchange authorization response to the inventory tracking system (step 811). The inventory tracking system updates the database to associate the label with the second user (step 812) and changes the state of the item listing to “borrowed” or “inactive” (step 813). The inventory tracking system sends an item exchange response to the communication device of the second user (step 814). The inventory tracking system also sends an item exchange confirmation to the communication device of the first user (step 815).

As further provided above, each label (or the code portion of the label) could be encrypted and the label may be validated before an item can be registered (or a transaction is performed). The code identifies a label issuer computer to which a validation request is sent. The label issuer computer decrypts the code, validates that the identifier has been issued and is available to be registered (e.g., not locked, etc.), and provides a security token to the inventory database that indicates that the label issuer computer approves of the transaction. The security token may be validated by the database before any changes in the assignment of labels to particular users is allowed.

A user may have the option to switch from virtual to physical label and vice versa. The physical label to virtual label switch is automatic because in the process of registration of a new item, the code portion of the code is one of the attributes of the item. The communication device can always generate the 2D virtual label from the code portion.

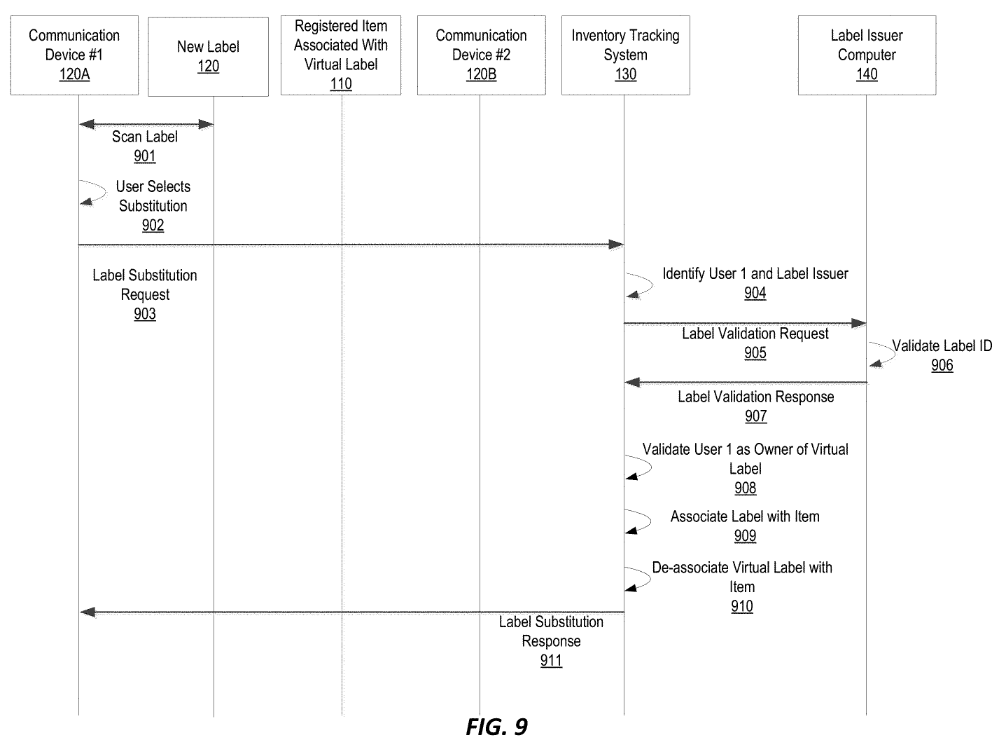

FIG. 9 illustrates a flowchart of steps for label substitution using the labeling and tracking system, according to various embodiments. The first user may scan a physical label using the communication device (step 901). The user may wish to substitute the physical label with the virtual label. The user may request a label switch on the communication device (step 902). The communication device may send a substitution request to the inventory tracking system (step 903). The inventory tracking system may identify the first user and identify a label issuer computer that generated the physical label (step 904). The inventory tracking system may send a label validation request to the label issuer computer (step 905). The label issuer computer may validate the label (step 906) and send a label validation response to the inventory tracking system (step 907). The inventory tracking system validates the first user as the owner of the newly generated label (step 908) and associates the label with the item on the database (step 909). The inventory tracking system de-associates the previous label with the item (step 910). The inventory tracking system sends a label substitution response to the communication device of the first user (step 911).

### Exemplary Labeling and Tracking System

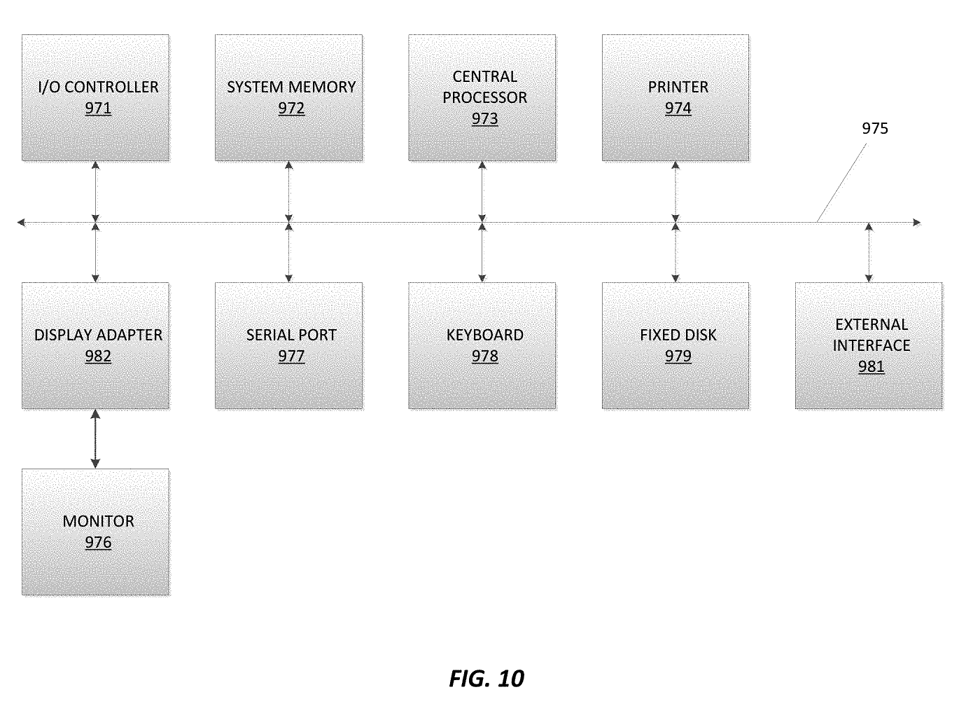

According to various embodiments discussed herein, an exemplary labeling and tracking system may include at least one database, a plurality of label issuing computers for issuing a plurality of labels, and an inventory tracking server in communication with the plurality of label issuing computers. Each of the label issuing computers and/or the inventory tracking system may include subsystems or components that are shown in FIG. 10. According to various embodiments, the exemplary labeling and tracking system may be in communication with at least one communication device such that a transaction request (e.g. a borrowing transaction associated with an item tagged with a label) is received from the at least one communication device.

The inventory tracking system may include a processor, an item registration module, a load distribution module and an item exchange processing module. For example, the item registration module may be programmed to (e.g. adapted to or capable of) receiving a label generation request to generate a label from a label requestor, and storing a label along with a description of an item associated with the label at the at least one database. The load distribution module may be programmed to (e.g. adapted to or capable of) identifying a label issuing computer among the plurality of label issuing computers based on a processing speed or a workload of each label issuing computer, sending the label generation request to the label issuing computer, and receiving the label from the label issuing computer. The label may include at least a first portion identifying the label issuing computer, and a second portion including an alpha-numerical code generated by the label issuing computer. The item exchange processing module may be programmed to (e.g. adapted to or capable of) receiving a transaction request including the label, determining that the label is generated by the label issuing computer based on the first portion of the label identifying the label issuing computer, transmitting the label to the label issuing computer for validation; receiving a validation result from the label issuing computer; and processing the transaction request based on the validation result. The transaction request may be associated with the item identified by the label, and processing the transaction request based on the validation result includes updating a status of the item identified by the label.

The various participants and elements described herein may operate one or more computer apparatuses to facilitate the functions described herein. Any of the elements in the above-described FIGS. 1-9, including any servers or databases, may use any suitable number of subsystems to facilitate the functions described herein.

Examples of such subsystems or components are shown in FIG. 10. The subsystems shown in FIG. 10 are interconnected via a system bus 975. Additional subsystems such as a printer 974, keyboard 978, fixed disk 979 (or other memory comprising computer readable media), monitor 976, which is coupled to display adapter 982, and others are shown. Peripherals and input/output (I/O) devices, which couple to I/O controller 971 (which can be a processor or other suitable controller), can be connected to the computer system by any number of means known in the art, such as serial port 977. For example, serial port 977 or external interface 981 can be used to connect the computer apparatus to a wide area network such as the Internet, a mouse input device, or a scanner. The interconnection via system bus allows the central processor 973 to communicate with each subsystem and to control the execution of instructions from system memory 972 or the fixed disk 979, as well as the exchange of information between subsystems. The system memory 972 and/or the fixed disk 979 may embody a computer readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

A recitation of “a”, “an” or “the” is intended to mean “one or more” unless specifically indicated to the contrary.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

One or more features from any embodiment may be combined with one or more features of any other embodiment without departing from the scope of the disclosure.

All patents, patent applications, publications, and descriptions mentioned above are herein incorporated by reference in their entirety for all purposes. None is admitted to be prior art.

What is claimed is:

1. A method comprising:
receiving, at an inventory labeling and tracking system, a label generation request to generate a label from a label requestor;
identifying, by the inventory labeling and tracking system, a label issuing computer among a plurality of label issuing computers based on a pre-determined criteria;
sending, by the inventory labeling and tracking system, the label generation request to the label issuing computer;
generating, by the inventory labeling and tracking system, a label in response to the label generation request using the label issuing computer, wherein the label includes at least a first portion identifying the label issuing computer, and a second portion including an alpha-numerical code generated by the label issuing computer;
returning, by the inventory labeling and tracking system, the label to the label requestor;
receiving, by the inventory labeling and tracking system, a transaction request including the label;
determining, by the inventory labeling and tracking system, that the label is generated by the label issuing computer based on the first portion of the label identifying the label issuing computer;
transmitting, by the inventory labeling and tracking system, the label to the label issuing computer for validation;
receiving, by the inventory labeling and tracking system, a validation result from the label issuing computer; and
processing, by the inventory labeling and tracking system, the transaction request based on the validation result.

2. The method of claim 1, wherein the pre-determined criteria includes a processing speed or a workload of each label issuing computer.

3. The method of claim 1, wherein the alpha-numerical code is an encrypted code.

4. The method of claim 1, wherein:
the plurality of label issuing computers includes a first label issuing computer and a second label issuing computer, and
the first label issuing computer is capable of generating a first number of alpha-numerical codes, and the second label issuing computer is capable of generating a second number of alpha-numerical codes such that each alpha-numerical code generated by the first label issuing computer is different than an alpha-numerical code generated by the second label issuing computer.

5. The method of claim 1, wherein the alpha-numerical code includes padding bits added by the label issuing computer.

6. The method of claim 1, further comprising:
requesting, by the inventory labeling and tracking system, a workload status of the plurality of label issuing computers;
determining, by the inventory labeling and tracking system, that a first label issuing computer among the plurality of label issuing computers has reached a limit of generating alpha-numerical codes based on the workload status of the first label issuing computer; and
requesting, by the inventory labeling and tracking system, the alpha-numerical code from a second label issuing computer among the plurality of label issuing computers based on the workload status of the second label issuing computer.

7. The method of claim 1 wherein the label includes a uniform resource identifier (URI) including at least the first portion and the second portion of the label.

8. A method comprising:
receiving, at a label issuing computer of an inventory labeling and tracking system, a label generation request to generate a label for a label requestor;
generating, by the label issuing computer, a label in response to the label generation request, wherein the label includes at least a first portion identifying the label issuing computer, and a second portion including a unique alpha-numerical code generated by the label issuing computer;
returning, using the label issuing computer, the label to the label requestor;
receiving, by the label issuing computer, the label for validation, wherein the validation includes validating that the label is generated by the label issuing computer;
analyzing, by the label issuing computer, the label to determine whether the label is generated by the label issuing computer; and
transmitting, by the label issuing computer, a validation result to the inventory labeling and tracking system, wherein a transaction including the label is authorized based on the validation result.

9. The method of claim 8, wherein generating the label further comprises:
retrieving, by the label issuing computer, a value of a first counter and a value of a second counter;
forming, by the label issuing computer, the unique alpha-numerical code by using the value of the first counter and the value of the second counter, such that the value of the first counter forms a first portion of the unique alpha-numerical code and the value of the second counter forms a second portion of the unique alpha-numerical code.

10. The method of claim 8, wherein the unique alpha-numerical code is formed of a plurality of portions.

11. The method of claim 10, further comprising:
retrieving, by the label issuing computer, a value of a first counter, such that the value of the first counter forms a first portion of the plurality of portions of the unique alpha-numerical code; and
retrieving, by the label issuing computer, a value of a second counter, such that the value of the second counter forms a second portion of the plurality of portions of the unique alpha-numerical code.

12. The method of claim 11, wherein the first counter identifies a first property of an item identified by the label and the second counter identifies a second property of the item identified by the label.

13. The method of claim 8, further comprising:
encrypting, by the label issuing computer, the unique alpha-numerical code.

14. The method of claim 8, further comprising:
adding, by the label issuing computer, padding bits to the unique alpha-numerical code;
encrypting, by the label issuing computer, the unique alpha-numerical code along with the padding bits.

15. The method of claim 8, further comprising:
encoding the unique alpha-numerical code into a data matrix.

16. The method of claim 8, wherein the analyzing further comprises:
determining, by the label issuing computer, that the label is encrypted;
applying, by the label issuing computer, a decryption algorithm available to the label issuing computer to the label;
generating, by the label issuing computer, the validation result validating the label if the label is decrypted using the decryption algorithm; and
generating, by the label issuing computer, the validation result not validating the label if the label cannot be decrypted using the decryption algorithm.

17. A labeling and tracking system comprising:
at least one database;
a plurality of label issuing computers for issuing a plurality of labels;
an inventory tracking server in communication with the plurality of label issuing computers, wherein the inventory tracking server includes:
a processor;
an item registration module for:
receiving a label generation request to generate a label from a label requestor, and
storing a label along with a description of an item associated with the label at the at least one database;
a load distribution module for:
identifying a label issuing computer among the plurality of label issuing computers,
sending the label generation request to the label issuing computer, and
receiving the label from the label issuing computer, wherein the label includes at least a first portion identifying the label issuing computer, and a second portion including an alpha-numerical code generated by the label issuing computer;
an item exchange processing module for:
receiving a transaction request including the label, wherein the transaction request is associated with the item identified by the label;
determining that the label is generated by the label issuing computer based on the first portion of the label identifying the label issuing computer;
transmitting the label to the label issuing computer for validation;
receiving a validation result from the label issuing computer; and
processing the transaction request based on the validation result.

18. The system of claim 17, wherein the processing the transaction request based on the validation result includes updating a status of the item identified by the label.

19. The system of claim 17, wherein the system is in communication with at least one communication device such that the transaction request is received from the at least one communication device.

20. The system of claim 17, wherein the load distribution module identifies the label issuing computer based on a processing speed or a workload of each label issuing computer.
